(19) United States
(12) Patent Application Publication
(10) Pub. No.: US 2025/0282223 A1
(43) Pub. Date: Sep. 11, 2025

(54) INFORMATION PROCESSING DEVICE, CONTENT PROVIDING METHOD, VEHICLE, AND PROGRAM

(71) Applicant: TOYOTA BOSHOKU KABUSHIKI KAISHA, Aichi (JP)

(72) Inventors: Osamu KAWASE, Aichi (JP); Tetsuro SAKAGUCHI, Aichi (JP); Hiroki ASHIZAWA, Aichi (JP); Nobuki HAYASHI, Aichi (JP); Yuki KAMIYA, Aichi (JP); Tomonori ISHIKAWA, Aichi (JP)

(73) Assignee: TOYOTA BOSHOKU KABUSHIKI KAISHA, Aichi (JP)

(21) Appl. No.: 19/013,128

(22) Filed: Jan. 8, 2025

(30) Foreign Application Priority Data
Mar. 8, 2024 (JP) 2024-036168

(51) Int. Cl. B60K 35/65; B60K 35/28; B60K 35/81

(52) U.S. Cl. CPC B60K 35/656; B60K 35/28; B60K 35/81; B60K 2360/182; B60K 2360/731; B60K 2360/741

(57) ABSTRACT

An information processing device includes: an information obtaining section configured to obtain attribute information of first and second passengers; a determining section configured to determine, on the basis of the attribute information, first and second content which are to be provided to the first and second passengers; and an output control section configured to cause the first and second content to be provided to the first and second passengers.

This Nonprovisional application claims priority under 35 U.S.C. § 119 on Patent Application No. 2024-036168 filed in Japan on Mar. 8, 2024, the entire contents of which are hereby incorporated by reference.

### TECHNICAL FIELD

The present disclosure relates to an information processing device, a content providing method, a vehicle, and a program.

### BACKGROUND ART

Patent Literature 1 discloses a system that displays, in a display section provided at a position visually recognizable by a passenger of a vehicle, content corresponding to according to the attribute or position of the passenger.

### CITATION LIST

### Patent Literature

### [Patent Literature 1]

Japanese Patent Application Publication, Tokukai, No. 2022-58312

### SUMMARY OF INVENTION

### Technical Problem

According to the system disclosed in Patent Literature 1, in a case where a plurality of passengers having different attributes are on board, content cannot sometimes be appropriately output to the plurality of passengers.

An aspect of the present disclosure has an object to appropriately output content even in a case where a plurality of passengers having different attributes are on board.

### Solution to Problem

In order to attain the object, an information processing device in accordance with one aspect of the present disclosure is an information processing device that controls an output section, which is used to output content, so as to provide the content to a first passenger and a second passenger who are on a traveling body, the information processing device including: an information obtaining section configured to obtain pieces of attribute information indicative of attributes of the first and second passengers; a determining section configured to determine, on a basis of the pieces of attribute information of the first and second passengers, first content which is to be provided to the first passenger and second content which is to be provided to the second passenger; and an output control section configured to cause the first content to be provided from the output section to the first passenger and to cause the second content to be provided from the output section to the second passenger.

In order to attain the object, a content providing method in accordance with another aspect of the present disclosure is a content providing method that controls an output section, which is used to output content, so as to provide the content to a first passenger and a second passenger who are on a traveling body, the content providing method including: obtaining pieces of attribute information indicative of attributes of the first and second passengers; determining, on a basis of the pieces of attribute information of the first and second passengers, first content which is to be provided to the first passenger and second content which is to be provided to the second passenger; and causing the first content to be provided from the output section to the first passenger and causing the second content to be provided from the output section to the second passenger.

An information processing device in accordance with each aspect of the present disclosure may be realized by a computer. In this case, the present disclosure encompasses: a program for the information processing device, the program causing a computer to operate as the sections (software elements) included in the information processing device so that the information processing device is realized by the computer; and a computer-readable storage medium in which the program is stored.

### Advantageous Effects of Invention

In accordance with an aspect of the present disclosure, it is possible to appropriately output content even in a case where a plurality of passengers having different attributes are on board.

### BRIEF DESCRIPTION OF DRAWINGS

FIG. 1 is a block diagram illustrating an example of a configuration of a content providing system including an information processing device in accordance with an embodiment of the present disclosure.

FIG. 2 is a view schematically illustrating an internal structure of a vehicle in accordance with an embodiment of the present disclosure.

FIG. 3 is a view illustrating an example of a configuration of an information processing device in accordance with an embodiment of the present disclosure.

FIG. 4 is a view used to explain an output control section.

### DESCRIPTION OF EMBODIMENTS

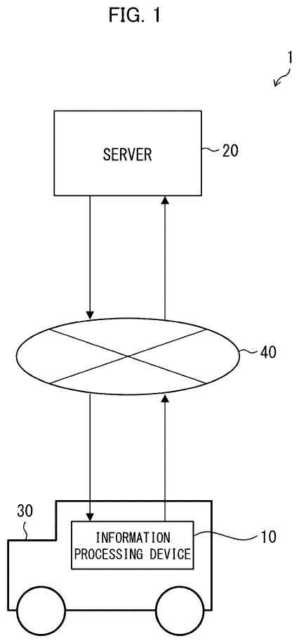

FIG. 1 is a block diagram illustrating an example of a configuration of a content providing system including an information processing device in accordance with an embodiment of the present disclosure. A content providing system 1 shown in FIG. 1 includes an information processing device 10 and a server 20. The information processing device 10 is disposed inside a vehicle 30, for example. The vehicle 30 is one example of a traveling body which can accommodate a plurality of passengers therein. Examples of the vehicle 30 include a bus and a shared taxi.

The server 20 is disposed outside the information processing device 10. The server 20 provides, to a passenger on the vehicle 30, a web service for seat reservation. When making seat reservation, the passenger on the vehicle 30 registers his/her attribute(s) in the server 20. The attribute(s) of the passenger include a destination, a gender, an age, nationality, and/or his/her language.

The information processing device 10 provides content to the passenger on the vehicle 30. The content can be sensed by the passenger with five senses. For example, the content include a video, an audio, a vibration, an odor, and/or mist. In the server 20, content that the information processing device 10 provides to the passenger is stored.

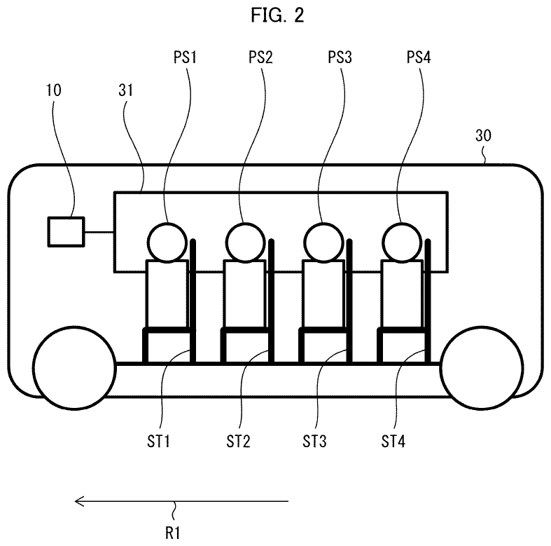

FIG. 2 is a view schematically illustrating a cross section of a vehicle in accordance with an embodiment of the present disclosure. As shown in FIG. 2, in the vehicle 30, a plurality of seats ST1 to ST4 are arranged and a plurality of passengers PS1 to PS4 are on board. A traveling direction R1 of the vehicle 30 is defined as indicated by the arrow shown in FIG. 2. The traveling direction R1 is one example of the traveling direction. The seats ST1 to ST4 are arranged along the traveling direction R1 of the vehicle 30. The passengers PS1 to PS4 are examples of the first and second passengers.

Each of the plurality of seats ST1 to ST4 is, e.g., a rotating cross seat, and is configured so that a seating direction thereof is changeable. In FIG. 2, the seating directions of the seats ST1 to ST4 are oriented in the traveling direction R1 of the vehicle 30. Each of the seats ST1 to ST4 is provided with a sensor for detecting the seating direction.

Inside the vehicle 30, a display device 31 is provided. The display device 31 shown in FIG. 2 is one example of the output section, and is a transmissive display disposed at a position of a window of the vehicle 30. The display device 31 has a display area which is elongated in a front-rear direction of the vehicle 30 so as to allow at least part of the display area is visually recognizable by all the passengers PS1 to PS4 sitting on the seats ST1 to ST4. The display device 31 is connected to the information processing device 10, and is used to output video content.

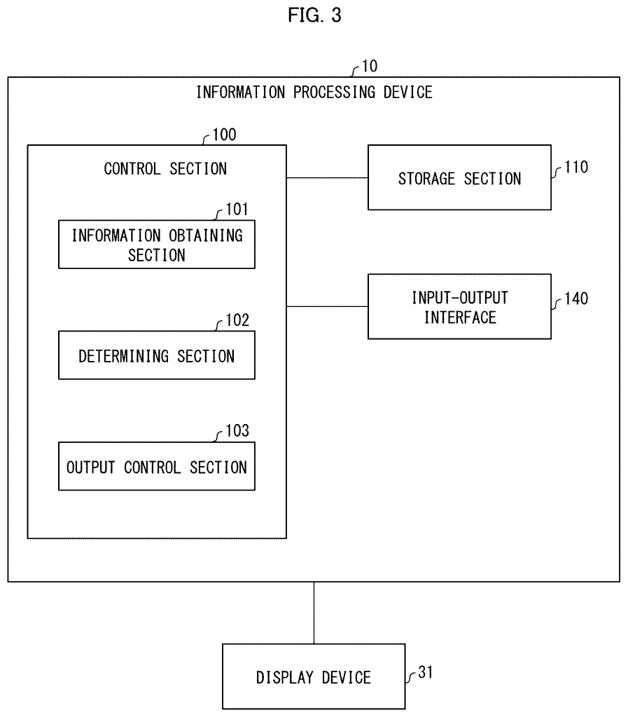

FIG. 3 is a view illustrating an example of a configuration of an information processing device in accordance with an embodiment of the present disclosure. As shown in FIG. 3, the information processing device 10 includes a control section 100, a storage section 110, and an input-output interface 140.

The control section 100 includes, for example, a central processing unit (CPU) and a main storage device. The storage section 110 includes, for example, a hard disk drive (HDD) and a solid state drive (SSD). In the storage section 110, a program which is to be executed by the control section 100 and data of content transmitted from the server 20 are stored.

The input-output interface 140 is, for example, a universal serial bus (USB) terminal or a local area network (LAN) terminal. The information processing device 10 is connected to a vehicle communication network such as a controller area network (CAN) via the input-output interface 140. The information processing device 10 is connectable to the display device 31 of the vehicle 30 or the network 40 via the CAN. The information processing device 10 can obtain information about a result of detection of seating directions from, e.g., the sensors of the seats ST1 to ST4 via the input-output interface 140.

By executing the program stored in the storage section 110, the control section 100 functions as an information obtaining section 101, a determining section 102, and an output control section 103.

The information obtaining section 101 obtains pieces of attribute information indicative of attributes of the passengers PS1 to PS4 on the vehicle 30. For example, the information obtaining section 101 obtains the pieces of attribute information of the passengers PS1 to PS4 from the server 20. Further, the information obtaining section 101 obtains, from, e.g., the sensors of the sensors seats ST1 to ST4, the information regarding the seating directions of the seats ST1 to ST4 and/or the like.

On the basis of the pieces of attribute information of the passengers PS1 to PS4 obtained by the information obtaining section 101, the determining section 102 determines pieces of content which are to be provided to the passengers PS1 to PS4. For example, as the pieces of content which are to be provided to the passengers PS1 to PS4, the determining section 102 determines, from among content stored in the server 20, content for carrying out sightseeing guidance on the destinations registered by the passengers PS1 to PS4 in the languages registered by the passengers PS1 to PS4. Further, on the basis of the genders, ages, nationalities and languages registered by the passengers PS1 to PS4, the determining section 102 determines, as the pieces of content which are to be provided to the passengers PS1 to PS4, advertisement content in which the passengers PS1 to PS4 are likely to be interested.

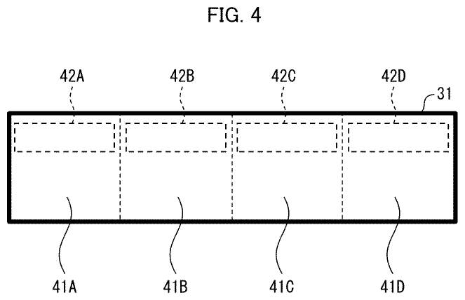

FIG. 4 is a view used to explain the output control section 103. The output control section 103 causes the content determined by the determining section 102 for the passengers PS1 to PS4 to be provided to the passengers PS1 to PS4. The explanation with reference to FIG. 4 is based on the assumption that the determining section 102 has selected video content as the pieces of content which are to be provided to the passengers PS1 to PS4. The output control section 103 outputs, via the display device 31, pieces of video content which are to be provided to the passengers PS1 to PS4.

The output control section 103 outputs the pieces of video content which are to be provided to the passengers PS1 to PS4 to a display area of the display device 31 which display area is visually recognizable by the passengers PS1 to PS4. In FIG. 4, display areas 41A to 41D are illustrated as the display area of the display device 31. The display areas 41A to 41D are examples of the first and second areas. The display areas 41A to 41D respectively have upper display areas 42A to 42D in their upper portions.

While the seat ST1 is oriented in the traveling direction R1 of the vehicle 30, the passenger PS1 can visually recognize the display area 41A. While the seat ST1 is oriented in a direction reverse to the traveling direction R1 of the vehicle 30, the passenger PS1 can visually recognize the display area 41A and the upper display areas 42B to 42D. While the seat ST1 is oriented in the direction reverse to the traveling direction R1 of the vehicle 30 and the seat ST2 is oriented in the traveling direction R1 of the vehicle 30, i.e., while the seat ST1 and the seat ST2 face each other, the passenger PS1 can visually recognize the display area 41B.

While the seat ST2 is oriented in the traveling direction R1 of the vehicle 30, the passenger PS2 can visually recognize the display area 41B and the upper display area 42A. While the seat ST2 is oriented in the direction reverse to the traveling direction R1 of the vehicle 30, the passenger PS2 can visually recognize the display area 41B and the upper display areas 42C and 42D. Further, while the seat ST1 and the seat ST2 face each other, the passenger PS2 can visually recognize the display area 41A. While the seat ST2 and the seat ST3 face each other, the passenger PS2 can visually recognize the display area 41C.

While the seat ST3 is oriented in the traveling direction R1 of the vehicle 30, the passenger PS3 can visually recognize the display area 41C and the upper display areas 42A and 42B. While the seat ST3 is oriented in the direction reverse to the traveling direction R1 of the vehicle 30, the passenger PS3 can visually recognize the display area 41C and the upper display area 42D. Further, while the seat ST2 and the seat ST3 face each other, the passenger PS3 can visually recognize the display area 41B. While the seat ST3 and the seat ST4 face each other, the passenger PS3 can visually recognize the display area 41D.

While the seat ST4 is oriented in the traveling direction R1 of the vehicle 30, the passenger PS4 can visually recognize the display area 41D and the upper display areas 42A to 42C. While the seat ST4 is oriented in the direction reverse to the traveling direction R1 of the vehicle 30, the passenger PS4 can visually recognize the display area 41D. Further, while the seat ST3 and the seat ST4 face each other, the passenger PS4 can visually recognize the display area 41C.

On the basis of the orientations of the seats ST1 to ST4 and the pieces of attribute information of the passengers PS1 to PS4, the output control section 103 determines a display area for displaying pieces of video content for the passengers PS1 to PS4.

For example, while all the seats ST1 to ST4 are oriented in the traveling direction R1, the pieces of video content corresponding to the pieces of attribute information of the passengers PS1 to PS4 are respectively displayed on the display areas 41A to 41D.

In a case where a plurality of passengers are present in rows in which the seats ST1 to ST4 are present, it may be determined to display, on the display areas 41A to 41D for the respective rows, the pieces of video content corresponding to the pieces of attribute information for the passengers in the respective rows. For example, in a case where the seat ST1 is a seat for two persons, it may be determined (i) to display, on a lower half portion of the display area 41A, video content corresponding to attribute information of a passenger sitting on, among seats in the seat ST1, a seat relatively closer to the display device 31 and (ii) to display, on the upper half portion of the display area 41A, video content corresponding to attribute information of a passenger sitting on a seat relatively farther from the display device 31. In a case where pieces of attribution information of the plurality of passengers sitting on the seat ST1 are at least partially the same, it may be determined to display, on the display area 41A, video content corresponding to the common item in the pieces of attribute information.

In a case where pieces of attribute information of passengers of, among the seats ST1 to ST4, a plurality of seats arranged side by side along the traveling direction R1 are at least partially the same, it may be determined to display video content by using a display area that can be visually recognized by the plurality of passengers. For example, in a case where the attribute information of the passenger PS2 of the seat ST2 and the attribute information of the passenger PS3 of the seat ST3 are at least partially the same, it may be determined to display, on the display area 42B, video content corresponding to the common item in the pieces of attribute information.

In a case where pieces of attribute information of passengers of, among the seats ST1 to ST4, seats facing each other are at least partially the same, video content may be displayed by using display areas for two persons. For example, in a case where the seats ST1 and ST2 face each other and the pieces of attribute information of the passengers PS1 and PS2 are at least partially the same, it may be determined to display video content corresponding to the common item in the pieces of attribute information. In this process, the output control section 103 may determine to display video content by using the display areas 41A and 41B as a single display area.

In a case where all the seats ST1 to ST4 face the display device 31, it may be determined to use all the display areas 41A to 41D of the display device 31 to display video content corresponding to the common item in the pieces of attribute information of the passengers PS1 to PS4 of the seats ST1 to ST4. For example, in a case where all the destinations of the passengers PS1 to PS4 are the same, it may be determined to display video content for carrying out sightseeing guidance on the destination.

For some of the passengers PS1 to PS4 who wish to conceal the pieces of attribute information, it may be determined (i) not to display pieces of video content for the passengers on the upper display areas 42A to 42D and (ii) to display these pieces of video content on a display area being not the upper display areas 42A to 42D. For example, in a case where the passenger PS1 wishes to conceal his/her attribute information such as his/her destination, it may be determined not to display video content on the upper display area 42A that can be visually recognized by the other passengers PS2 to PS4. The information indicating whether or not a passenger wishes to conceal his/her attribute information may be registered in the server 20 in advance, e.g., when he/she reserves the seat.

On some of the display areas 41A to 41D which are close to, among the seats ST1 to ST4, a seat(s) on which no passenger sits, it may be determined not to display any content so as to allow the passenger(s) to enjoy the landscape outside the vehicle 30. Alternatively, some of the display areas 41A to 41D which are close to the seat(s) on which no passenger sits may be used to display a piece(s) of video content for other passenger(s) or may be used to display the advertisement content. For example, in a case where the passenger PS1 does not sit on the seat ST1, it may be determined (i) to display the video content for the passenger PS2 by using the display areas 41A and 41B, (ii) not to display anything on the display area 41A, or (iii) to display the advertisement content on the display area 41A.

In a case where the seats ST1 to ST4 are configured to allow their backrests to be tilted with respect to the seat surfaces, a display area that can be visually recognized by the passengers PS1 to PS4 can be changed according to the postures of the seats ST1 to ST4, e.g., angles of the backrests with respect to the seat surfaces. For example, when the backrest of the seat ST1 oriented in the traveling direction R1 is tilted toward the seat ST2, posture information including an angle of the backrest with respect to the seat surface of the seat ST1 may be output from the seat ST1 to the information processing device 10. In this process, the information processing device 10 may set, as the upper display area 42A, a display area that can be visually recognized by the passenger PS1.

### Effects

As explained above, according to the information processing device 10 in accordance with the present embodiment, it is possible to attain the following effects.

The information processing device 10 is an information processing device that controls the display device 31, which is used to output content, so as to provide the content to the first passenger PS1 or the like and the second passenger PS2 or the like who are on the vehicle 30. The information processing device 10 includes the information obtaining section 101, the determining section 102, and the output control section 103. The information obtaining section 101 obtains pieces of attribute information indicative of attributes of the first passenger PS1 or the like and the second passenger PS2 or the like. The determining section 102 determines, on the basis of the pieces of attribute information of the first passenger PS1 or the like and the second passenger PS2 or the like, first content which is to be provided to the first passenger PS1 or the like and second content which is to be provided to the second passenger PS2 or the like. The output control section 103 causes the first content to be provided from the display device 31 to the first passenger PS1 or the like and causes the second content to be provided from the display device 31 to the second passenger PS2 or the like. According to the above configuration, the information processing device 10 can appropriately output content even in a case where a plurality of passengers having different attributes are on board.

The information processing device 10 is provided to the vehicle 30, and is disposed at a position where the information processing device 10 is at least partially visually recognizable by the first passenger PS1 or the like and the second passengers PS2 or the like. On the basis of positions, orientations, and postures of seats on which the first passenger PS1 or the like and the second passenger PS2 or the like sit, the output control section 103 determines the first area 41A or the like that is visually observable by the first passenger PS1 or the like and the second area 41B that is visually observable by the second passenger PS2 or the like, and the output control section 103 causes the first content to be displayed on the first area 41A or the like and causes the second content to be displayed on the second area 41B. According to the above configuration, the information processing device 10 can appropriately output video content to a plurality of passengers.

While the first seat ST1 or the like on which the first passenger PS1 or the like sits and the second seat ST2 or the like on which the second passenger PS2 or the like sits face each other, the output control section 103 causes content corresponding to an attribute which is common to the first passenger PS1 or the like and the second passenger PS2 or the like to be displayed on an area that is visually recognizable by the first passenger PS1 or the like and the second passenger PS2 or the like. According to the above configuration, the information processing device 10 can appropriately output video content to a plurality of passengers sitting on seats facing each other.

The first seat ST1 or the like on which the first passenger PS1 or the like sits and the second seat ST2 or the like on which the second passenger PS2 or the like sits are arranged along the traveling direction R1 of the vehicle 30. The display devices 31 are disposed at positions of windows of side walls on the left and right sides as seen in the traveling direction R1 of the vehicle 30, and have display areas extending in the traveling direction R1. According to the above configuration, the display area is at least partially visually recognizable by both the first seat ST1 or the like and the second seat ST2 or the like.

The above-discussed content providing method is a method according to which the information processing device 10 controls the display device 31, which is used to output content, so as to provide the content to the first passenger PS1 or the like and the second passenger PS2 or the like who are on the vehicle 30. When functioning as the information obtaining section 101, the information processing device 10 obtains pieces of attribute information indicative of attributes of the first passenger PS1 or the like and the second passenger PS2 or the like. When functioning as the determining section 102, the information processing device 10 determines, on the basis of the pieces of attribute information of the first passenger PS1 or the like and the second passenger PS2 or the like, first content which is to be provided to the first passenger PS1 or the like and second content which is to be provided to the second passenger PS2 or the like. When functioning as the output control section 103, the information processing device 10 causes the first content to be provided from the display device 31 to the first passenger PS1 or the like and causes the second content to be provided from the display device 31 to the second passenger PS2 or the like. According to the above configuration, it is possible to appropriately output content even in a case where a plurality of passengers having different attributes are on board.

The vehicle 30 includes the information processing device 10 and the display device 31.

### Software Implementation Example

The functions of the information processing device 10 (hereinafter, referred to as a “device”) can be realized by a program for causing a computer to function as the device, the program causing the computer to function as the control blocks (particularly, the sections included in the control section 100) of the device.

In this case, the device includes, as hardware for executing the program, at least one control device (e.g., a processor) and at least one storage device (e.g., a memory). By causing the control device and the storage device to execute the program, the functions explained in the foregoing embodiments are realized.

The program may be recorded in one or more non-transitory computer-readable recording media. The recording media may or may not be included in the device. In the latter case, the program may be supplied to or made available to the device via any wired or wireless transmission medium.

Furthermore, some or all of functions of the control blocks can also be realized by a logic circuit. For example, the present disclosure encompasses, in its scope, an integrated circuit in which a logic circuit that functions as each of the above-described control blocks is formed. In addition, the function of each of the control blocks can be realized by, for example, a quantum computer.

The processes described in the foregoing embodiments may be carried out by artificial intelligence (AI). In this case, AI may be operated in the control device, or may be operated in another device (e.g., an edge computer or a cloud server).

### Variations

The foregoing embodiments have dealt with the content providing method that provides content while the vehicle 30 such as a bus or a shared taxi is traveling. However, the information processing device and the content providing method in accordance with one embodiment of the present disclosure are also applicable to provision of content carried out during traveling of a traveling body other than a bus or a shared taxi, e.g., a railroad train, an aircraft, or a ship.

In the foregoing embodiments, data of content that is to be provided from the determining section 102 to a passenger is obtained from the server 20. Alternatively, however, the data of the content may be stored in the storage section 110 of the information processing device 10 in advance.

In the foregoing embodiments, the control section 100 of the information processing device 10 provided inside the vehicle 30 functions as the information obtaining section 101, the determining section 102, and the output control section 103. Alternatively, however, the information processing device that functions as the information obtaining section 101, the determining section 102, and the output control section 103 may be provided outside the vehicle 30. For example, the server 20 may function as the information processing device.

The explanation in the foregoing embodiments has dealt with the case where the video content is provided by the display device 31. However, the content whose output is controlled by the output control section 103 is not limited to the video content. For example, the output control section 103 may control output of content of an audio, a vibration, mist, and an odor. For example, the vehicle 30 may include audio output sections (e.g., headphones and/or speakers) for the respective seats ST1 to ST4, and may output, via the audio output sections, audio information based on pieces of audio information. For example, the vehicle 30 may include the display device 31 having a vibrator which is provided to a back side of a display surface of the display device 31 and which provides vibration content, and may provide presentation of a video and vibration of the display surface. For example, the vehicle 30 may include a member for spraying mist and/or an odor component for each of the seats ST1 to ST4.

In the foregoing embodiments, the display device 31 is a transmissive display disposed at a position of the window of the vehicle 30. However, the display device 31 is not limited to this. For example, the display device 31 may be a non-transmissive display disposed at the position of the window of the vehicle 30. Alternatively, the display device 31 may be a display which is disposed on a ceiling, a floor surface, and/or the like of the vehicle 30 and which has a display area extending along the traveling direction R1. Further alternatively, the display device 31 may be constituted by combination of a plurality of displays. Still further alternatively, the display device 31 may be constituted by a screen and a projector. Yet further alternatively, the display device 31 may be displays provided to respective components (e.g., the seat ST1 of the vehicle 30), or may be an information terminal (e.g., a smartphone or a tablet terminal) possessed by a passenger.

### Supplementary Remarks

The present disclosure is not limited to the embodiments above, but can be altered by a skilled person in the art within the scope of the claims. The present disclosure also encompasses, in its technical scope, any embodiment derived by combining technical means disclosed in differing embodiments as appropriate.

### REFERENCE SIGNS LIST

10: information processing device
20: server
30: vehicle
31: display device
40: network
41A, 41B, 41C, 41D: display area
42A, 42B, 42C, 42D: upper display area
100: control section
101: information obtaining section
102: determining section
103: output control section
PS1, PS2, PS3, PS4: passenger
ST1, ST2, ST3, ST4: seat

1. An information processing device that controls an output section, which is used to output content, so as to provide the content to a first passenger and a second passenger who are on a traveling body, the information processing device comprising:
an information obtaining section configured to obtain pieces of attribute information indicative of attributes of the first and second passengers;
a determining section configured to determine, on a basis of the pieces of attribute information of the first and second passengers, first content which is to be provided to the first passenger and second content which is to be provided to the second passenger; and
an output control section configured to cause the first content to be provided from the output section to the first passenger and to cause the second content to be provided from the output section to the second passenger.

2. The information processing device according to claim 1, wherein:
the output section is a display device provided to the traveling body, the display device being disposed at a position where the display device is at least partially visually recognizable by the first and second passengers; and
the output control section determines, on a basis of positions, orientations, and postures of seats on which the first and second passengers sit, a first area that is visually observable by the first passenger and a second area that is visually observable by the second passenger, and the output control section causes the first content to be displayed on the first area and causes the second content to be displayed on the second area.

3. The information processing device according to claim 2, wherein:
while a first seat on which the first passenger sits and a second seat on which the second passenger sits face each other, the output control section causes content corresponding to an attribute which is common to the first and second passengers to be displayed on an area that is visually recognizable by the first and second passengers.

4. The information processing device according to claim 3, wherein:
the first and second seats are arranged along a traveling direction of the traveling body; and
the display device is provided to at least one selected from the group consisting of side walls located on left and right sides as seen in the traveling direction of the traveling body, a ceiling of the traveling body, and on a floor surface of the traveling body, each of the plurality of display devices having a display area extending in the traveling direction of the traveling body.

5. A content providing method that controls an output section, which is used to output content, so as to provide the content to a first passenger and a second passenger who are on a traveling body, the content providing method comprising:
obtaining pieces of attribute information indicative of attributes of the first and second passengers;
determining, on a basis of the pieces of attribute information of the first and second passengers, first content which is to be provided to the first passenger and second content which is to be provided to the second passenger; and
causing the first content to be provided from the output section to the first passenger and causing the second content to be provided from the output section to the second passenger.

6. A vehicle comprising:
an information processing device recited in claim 1; and
the output section.

7. A program for causing a computer to function as an information processing device recited in claim 1, the program causing the computer to function as the information obtaining section, the determining section, and the output control section.
